(19) United States
(12) Patent Application Publication
(10) Pub. No.: US 2002/0174773 A1
(43) Pub. Date: Nov. 28, 2002

(54) Dust Recovery device

(76) Inventor: Kuai-Chung Cheng, Chung-Li City (TW)

Correspondence Address: BACON & THOMAS, PLLC, 625 SLATERS LANE, FOURTH FLOOR, ALEXANDRIA, VA, 22314

(21) Appl. No.: 09/863,373

(22) Filed: May 24, 2001

(51) Int. Cl. B01D 47/00; B01D 45/12

(52) U.S. Cl. 96/278; 55/455

(57) ABSTRACT

A dust recovery device comprising an air drawing unit and a gravity centrifugal unit, wherein, an air blower in the air drawing unit is used to directly draw dust into a centrifuge cylinder of the gravity centrifugal unit. The air entering the gravity centrifugal unit can form a strong air whirling action by an air vortex generator to throw out the dust blending with air by the air whirling action and to evolve it out of the airflow when it is released from the air vortex. The evolved dust is guided by the wall of the centrifuge cylinder to drop into a dust collecting tank through a dust dropping hole, thereby, the dust is effectively recovered and are no more discharged into the atmosphere along with the airflow.

### BACKGROUND OF THE INVENTION

1. Field of the Invention

The present invention is related to a dust recovery device, the device can effectively draw and gather dust to prevent it from scattering into the air; and especially to a dust recovery device in which the airflow from an air drawing unit brings the dust into a gravity centrifugal unit. The airflow forms a strong air whirling action in a centrifuge cylinder by the action of an air vortex generator to throw out the dust blending with air by the centrifugal air whirling action and to have them evolved from the airflow. The evolved dust is guided by the wall of the centrifuge cylinder to drop into a dust collecting tank, thereby, the dust is effectively recovered and no more discharged into the atmosphere along with the airflow.

2. Description of the Prior Art

In the working fields of wood processing or working fields for cutting, grinding etc., the material and the machines in processing may create large amount of filings and dust; the filings or dust are small and are subjected to scattering into the air, the filings or dust blending with the air will flow in accompanying with air to fully fill a working field. People working there will probably feel uncomfortable by absorbing filings or dust during inspiration, and extreme substantial damage may be imposed on human bodies after long period suffering to such damage.

In view of this, common wood processing fields or working fields for cutting, grinding etc. mostly are provided with dust catching devices to draw the filings created in the fields into a suitable container, so that the filings will not be subjected to scattering into the air, and the air in the working fields can be purified.

However, conventional dust catching devices stop filings in the air with filtering nets, and the filings are accumulated in a receiving space, thereby, if the recovered filings are too small, they may not be effectively stopped by the filtering nets and again are moved into the air, not mentioning the dust which are even smaller.

Conventional dust catching devices normally can only collect dust with larger granules, thereby, when in recovering dust with smaller granules, pressure shall be added by increasing horse powers, this is not good in effective using an energy source.

And more, conventional dust catching devices add therein filtering nets or dust collecting bags to intercept finer dust effectively, however, not only the filtering nets or dust collecting bags render are subjected to blocking and need changing.

### SUMMARY OF THE INVENTION

In view of these, the primary object of the recovery device for dust of the present invention is to render an air drawing unit to bring dust into a gravity centrifugal unit. The airflow forms a strong air whirling action in a centrifuge cylinder by the action of an air vortex generator to throw out the dust blending with air by the centrifugal air whirling action and to have them evolved from the airflow. The evolved dust is guided by the wall of the centrifuge cylinder to drop into a dust collecting tank, thereby, the dust is effectively recovered and is no more discharged into the atmosphere along with the airflow.

Another object of the present invention is to provide a by-pass pipe by the centrifuge cylinder; a by-pass hole led to the by-pass pipe is formed on the upper wall of the centrifuge cylinder. By providing the by-pass hole, dust raised with the whirling the air can get in the by-pass pipe through the by-pass hole, and then drop into the dust collecting tank through the dust dropping pipe; this can increase recovery effect of the lighter dust.

Another object of the present invention is to provide a water bathing device at the tailing end of an air exhausting pipe, so that the airflow the airflow discharged can be processed by the water bathing device to evolve the fine molecules of dust blending with the airflow to thereby increase the effect of purifying air.

The present invention will be apparent after reading the detailed description of the preferred embodiment thereof in reference to the accompanying drawings.

### BRIEF DESCRIPTION OF THE DRAWINGS

FIG. 1 is a perspective view showing the appearance of the first embodiment of the present invention;

FIG. 2 is a partial exploded perspective view showing the structure of a gravity centrifugal unit of the present invention;

FIG. 3 is a schematic sectional view showing the state of evolving of dust by centrifugal action in the present invention;

FIG. 4 is a schematic sectional view showing the state of airflow discharging after evolving of dust by centrifugal action in the present invention;

FIG. 5 is a sectional view showing the structure of a water bathing device provided at the tailing end of an air exhausting pipe of the present invention;

FIG. 6 is a sectional view showing assembling of the structure of a by-pass pipe provided nearby a second centrifuge cylinder when twin centrifuge cylinders are used for the present invention.

### DETAILED DESCRIPTION OF THE PREFERRED EMBODIMENT

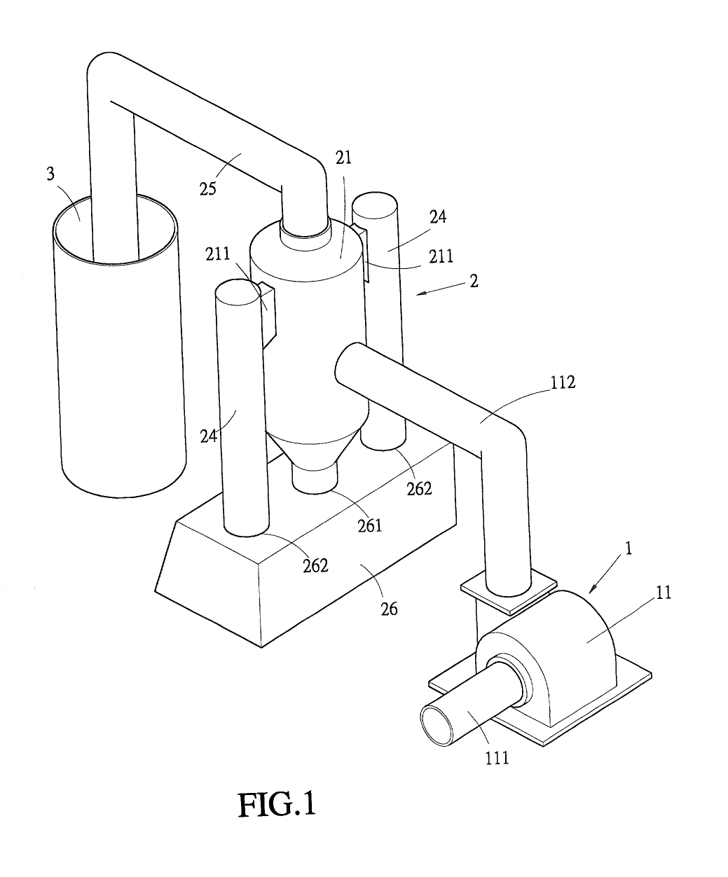

As shown in FIG. 1, the recovery device for dust of the present invention is comprised basically of an air drawing unit 1 and a gravity centrifugal unit 2, wherein, the air drawing unit 1 has an air blower 11 which can generate an airflow for drawing in dust. An air drawing pipe 111 is led to the area which generates dust, the dust drawn is sent into a gravity centrifugal unit 2 via an air guiding pipe 112 in accompanying with the airflow for centrifugal evolving.

An upright centrifuge cylinder 21 is provided in the gravity centrifugal unit 2 having the aforesaid air guiding pipe 112 which guides the airflow with the dust into the centrifuge cylinder 21 at the middle of the centrifuge cylinder 21 to render the airflow to create centrifugation to evolve the dust. A dust collecting tank 26 is provided beneath the centrifuge cylinder 21 to collect the dust dropping due to gravity, lastly, an air exhausting pipe 25 is provided on the top of the centrifuge cylinder 21 for discharging the airflow. And a water bathing device 3 is provided at the tailing end of the air exhausting pipe 25 of the gravity centrifugal unit 2, so that the airflow can be processed by the water bathing device 3 to evolve the fine molecules of dust blending with the airflow to thereby increase the effect of purifying the air.

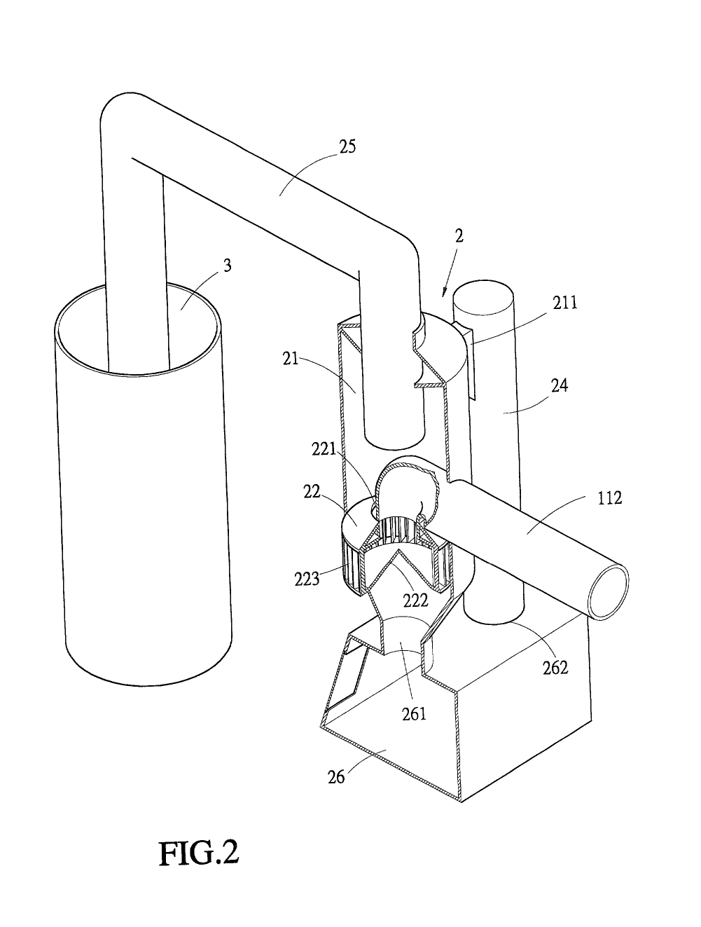

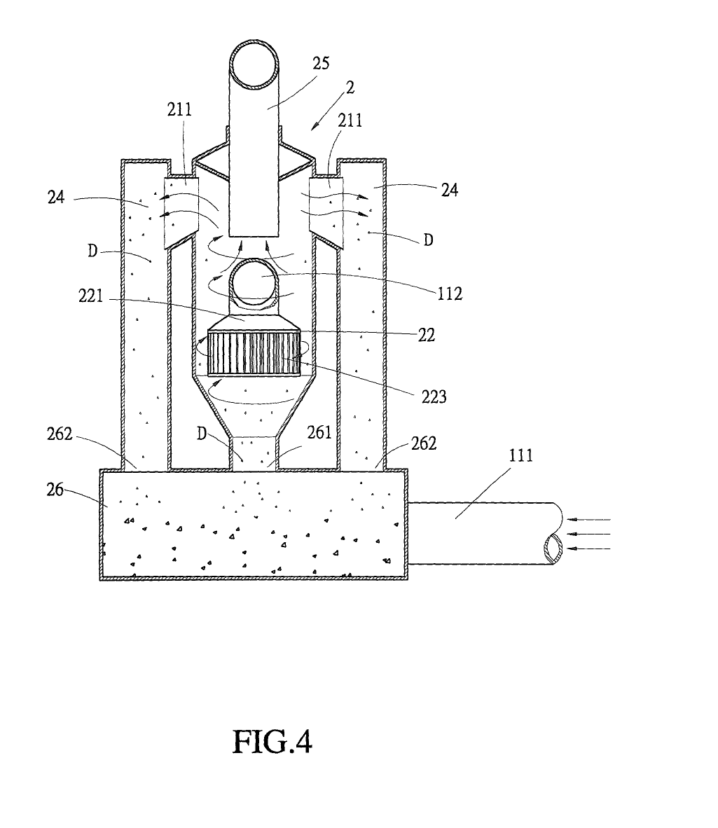

Referring to FIGS. 2 and 4, the gravity centrifugal unit 2 of the present invention has an air vortex generator 22 provided in the centrifuge cylinder 21; the air vortex generator 22 is provided at the center of the centrifuge cylinder 21 and is a structure in the shape of a round barrel, an air inlet 221 is provided on the top thereof to connect with the air guiding pipe 112; a plurality of inclining air guiding leaves 223 are provided around the round barrel. An air guiding cone 222 is formed on the bottom of the round barrel to guide the airflow smoothly to the peripheral area thereof, thereby, when the airflow enters the centrifuge cylinder 21 from the air guiding pipe 112, the air guiding leaves 223 on the air vortex generator 22 create internally a strong air whirling action in the centrifuge cylinder 21. The airflow subjected to the air whirling action and revolves along the inner wall of the centrifuge cylinder 21 to be raised gradually and finally discharged out of the air exhausting pipe 25 provided on the top of the centrifuge cylinder 21.

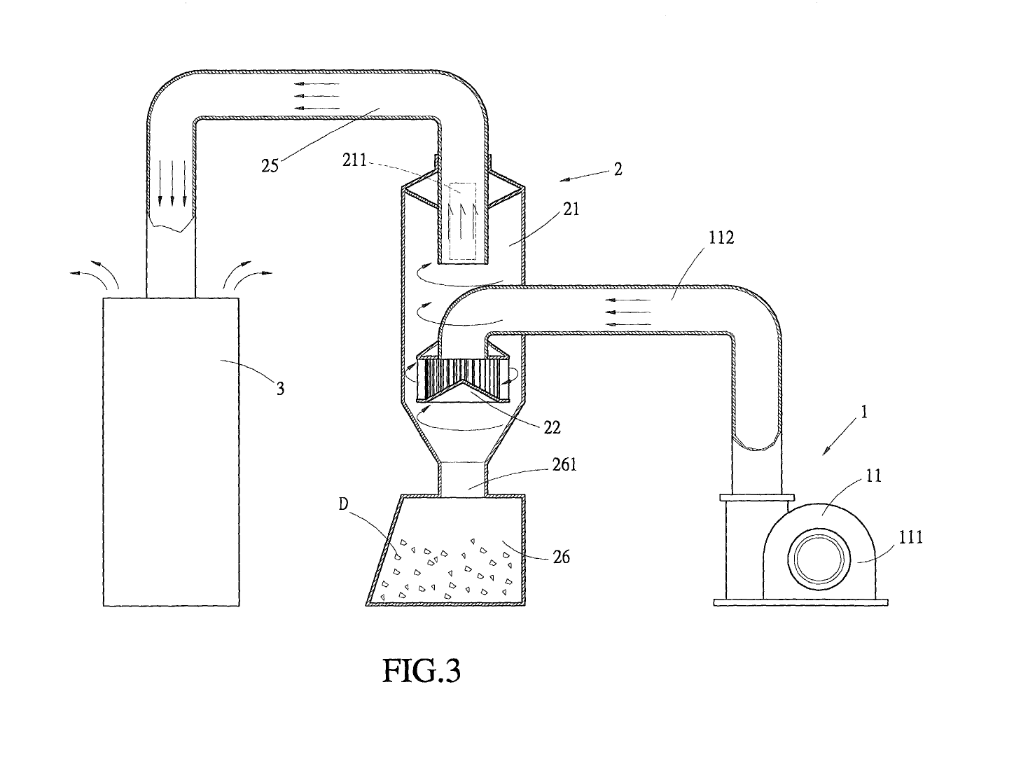

As shown in FIGS. 1-4, the centrifuge cylinder 21 of the present invention is provided with a by-pass pipe 24 by the centrifuge cylinder 21, a by-pass hole 211 led to the by-pass pipe 24 is formed on the upper wall of the centrifuge cylinder 21. So that when the airflow revolves in the centrifuge cylinder 21 by the strong air whirling action, the dust “D” blending with air is thrown out by the centrifugal force created by the air whirling action and are separated and evolved from the airflow. The evolved dust “D” is guided by the wall of the centrifuge cylinder 21 to drop by gravity into a dust collecting tank 26 through a dust dropping hole 261 on the bottom of the centrifuge cylinder 21. When the airflow revolves and is raised towards the air exhausting pipe 25, the dust “D” not evolved yet can enter the by-pass pipe 24 via the by-pass hole 211 in the first place before getting in the air exhausting pipe 25, and then are led by the by-pass pipe 24 to drop into the dust collecting tank 26 through a dust dropping hole 262′ on the lower end of the by-pass pipe 24, this can increase the recovery effect of the dust “D” with smaller weight by the air whirling action.

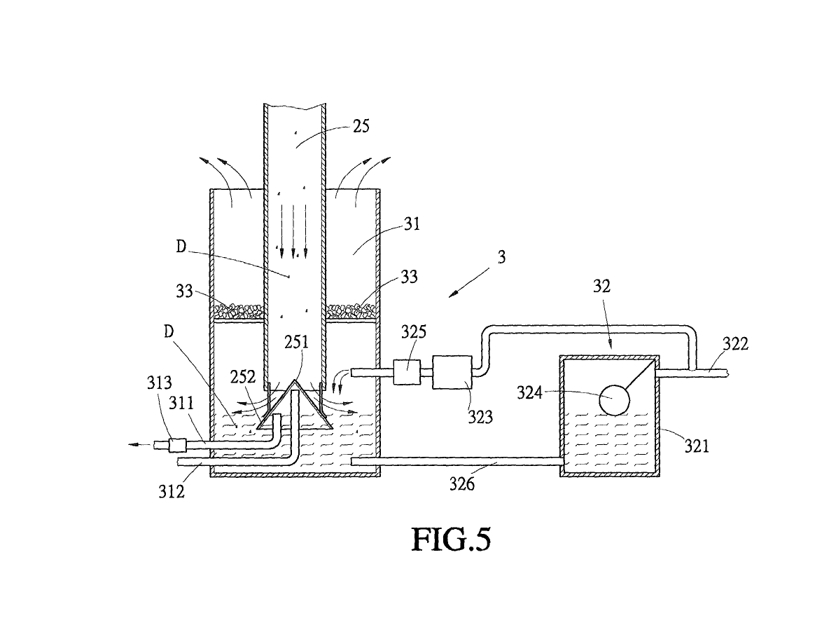

Moreover, in practical operation of the recovery device for dust of the present invention, the structure of the water bathing device 3 at the tailing end of the air exhausting pipe 25 is depicted in FIG. 5. Wherein, the water bathing device 3 has a main member, i.e. a water bathing tank 31, which has at one side thereof a water feed-in control set 32. The water bathing tank 31 has therein a receiving chamber which can be extended therein an air discharging end of the above-mentioned air exhausting pipe 25 which is provided on the air discharging end with an air concentration lid 251. The water bathing tank 31 has near the bottom thereof a water outlet 311 and a water drain pipe 312, the water outlet 311 is provided thereon with a switch 313 for controlling volume of water flow. The water outlet 311 and the water drain pipe 312 of the water bathing tank 31 are located beneath the air concentration lid 251, the height of the water outlet 311 is about the standard water level of the water bathing tank 31, while the height of the water drain pipe 312 almost reaches the top inner surface of the air concentration lid 251.

The water feed-in control set 32 includes a water inlet pipe 322 and a water level control room 321. Wherein, the water inlet pipe 322 is connected to the lower portion of the water bathing tank 31 through an electromagnetic valve 323 and a ball valve 325 to control volumes of water feeding and discharging and to maintain the standard water level in the water bathing tank 31. The water inlet pipe 322 is connected with the water level control room 321 which has therein a ball float 324 and communicates on the bottom thereof with the bottom of the water bathing tank 31 through a communicating pipe 326 in order to keep the standard water level in the water bathing tank 31.

By providing the above stated water bathing device, when the water inlet pipe 322 feeds water to the water bathing tank 31, amount of feeding water is larger than the amount of outputting of the water outlet 311, so that the water level of the water bathing tank 31 is higher than the height of the water outlet 311; at this time, water will continuously be discharged from the water outlet 311 in the mode of water circulation.

When the dust “D” enters the water bathing tank 31 from the air exhausting pipe 25 in accompanying with air, the airflow will move upwardly to create water spray after moving along the beveled surfaces of the air concentration lid 251 and the water surface, the dust “D” can thereby enter the water. After the airflow moves upwardly of the water bathing tank 31, it is partially combined with the water molecules in the water bathing tank 31, so that the fine dust “D” in the airflow can drop into the water. Moreover, the water bathing tank 31 can be provided at the upper portion thereof with a water stop member 33. In this way, water in the water bathing tank 31 can be prevented from spattering outwardly by blowing of airflow.

The feeding water amount of the water inlet pipe 322 is larger than the amount of outputting of the water outlet 311, so that when the water in the water bathing tank 31 is continuously discharged out of the water outlet 311, the water level in the water bathing tank 31 can keep on getting higher and higher. And during increasing of the water level, water will enter the air concentration lid 251 continuously by the air pressure, so that the air in the air concentration lid 251 is discharged out of the water drain pipe 312. When the air in the air concentration lid 251 is exhausted, water is discharged out of the water drain pipe 312 (by the siphon action) in a mode of discharging with large amount, thus dirt water can be fast discharged.

And more, when the water in the water bathing tank 31 is fast discharged out of the water drain pipe 312, the water level in the water bathing tank 31 will drop continuously, and when the water is lowered to a water level hole 252 provided on the air concentration lid 251, the air will get inside of the air concentration lid 251 to break down the siphon action, this can prevent the water drain pipe 312 from going on discharging water, at this time, the water level of the water bathing tank 31 is lower than the standard water level.

When the water level of the water bathing tank 31 is lower than the standard water level, the water level control room 321 will feed water fast, and the water inlet pipe 322 recovers feeding water continuously to make the water level of the water bathing tank 31 get back fast to the standard water level to form the circulating state of water getting in and out. By the fact that amount of feeding water of the water inlet pipe 322 is larger than the amount of outputting of the water outlet 311 to render the latter to continuously discharge water. The water inlet pipe 322 controls water feeding mainly by the electromagnetic valve 323, volume of water feeding is controlled by the ball valve 324 and the water level control room 321 to maintain the standard water level of the water bathing tank 31, while volume of water outputting is adjusted by means of the water level control room 321. Thereby, the water bathing device 3 can continuously discharge water through the water outlet 311, under the siphon action, the water drain pipe 312 can be in the circulation state wherein it can discharge dirt water with large amount timely, and water in the water bathing tank 31 can flow fast to keep cleanliness of water.

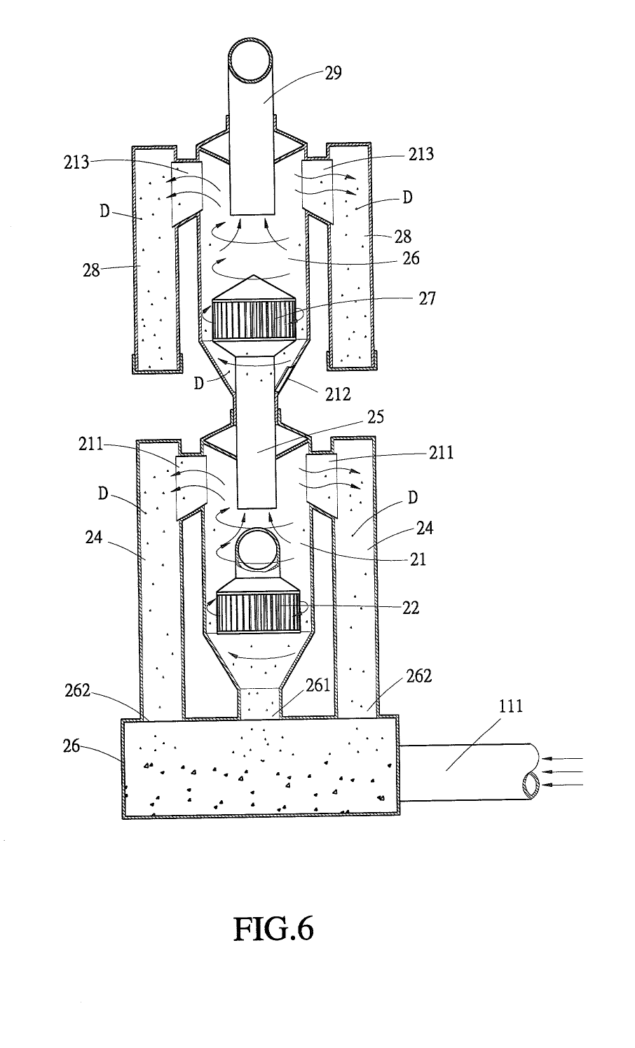

Referring to FIG. 6, when in operation of the dust recovery device of the present invention, two centrifuge cylinders can be arranged in the gravity centrifugal unit. That is, the tailing end of the air exhausting pipe 25 of the centrifuge cylinder 21 is connected further with a second centrifuge cylinder 26′, the air discharging end of the abovementioned air exhausting pipe 25 is directly connected to an air vortex generator 27′ provided in the centrifuge cylinder 26′, in order that the airflow can further generate an air whirling action in the centrifuge cylinder 26′ to evolve the dust “D” remaining in the airflow.

The second centrifuge cylinder 26′ is provided with a by-pass hole 213′ and a by-pass pipe 28′. When the airflow in the second centrifuge cylinder 26′ revolves and is raised towards the air exhausting pipe 29′, the dust “D” not evolved yet can enters the by-pass pipe 28′ via the by-pass hole 211′ in the first place before getting in the air exhausting pipe 29′. And a slag discharging gate 212 is directly provided on the lower end of the second centrifuge cylinder 26′ for clearing of the dust “D” dropping in the second centrifuge cylinder 26′.

The centrifugal force generated by the air whirling action in the dust recovery device of the present invention not only evolves the dust out of the airflow and renders it to drop into the dust collecting tank by gravity, but also can generate the air whirling action without any aid but only by means of the physical feature of the air vortex generator provided in the gravity centrifugal unit to thereby completely evolve and recover the dust of larger and smaller volumes in the air under the centrifugal force. The dust recovery device can not only effectively recover the dust in the air, but can also render the discharged circulating airflow to contain no fine dust granules; this is a better and practicable dust recovery device. Having thus described my invention,

What I claim as new and desire to be secured by Letters Patent of the United States are:

1. A dust recovery device comprising an air drawing unit and a gravity centrifugal unit, wherein,
said air drawing unit has an air blower which generates an airflow for drawing in dust, and has an air drawing pipe led to the area which generates dust, the dust drawn is sent into said gravity centrifugal unit via an air guiding pipe in accompanying with the airflow for centrifugal evolving;
said gravity centrifugal unit is provided therein with an upright centrifuge cylinder, an air vortex generator is provided in said centrifuge cylinder connected with said air guiding pipe, a dust collecting tank is provided beneath said centrifuge cylinder, a dust dropping hole is provided on the lower end of said centrifuge cylinder in communication with said dust collecting tank, an air exhausting pipe is provided on the top of said centrifuge cylinder for discharging airflow;
when said airflow is drawn into said centrifuge cylinder by means of said air blower, said gravity centrifugal unit forms a strong air whirling action by said air vortex generator to throw out the dust blending with air by said air whirling action and to evolve said dust from said airflow when it is released from air vortex; said evolved dust is guided by the wall of said centrifuge cylinder to drop into said dust collecting tank through said dust dropping hole, thereby, said dust is effectively recovered and is no more discharged into the atmosphere along with said airflow.

2. A dust recovery device as in claim 1, wherein,
said air vortex generator is provided at the center of said centrifuge cylinder and is a structure in the shape of a round barrel, an air inlet is provided on the top thereof to connect with said air guiding pipe; a plurality of inclining air guiding leaves are provided around said round barrel; an air guiding cone is formed on the bottom of said round barrel to guide said airflow smoothly to the peripheral area thereof.

3. A dust recovery device as in claim 1, wherein,
said centrifuge cylinder is provided by itself with a by-pass pipe, a by-pass hole led to said by-pass pipe is formed on the upper wall of said centrifuge cylinder, when said airflow revolves and is raised towards said air exhausting pipe, the dust not evolved yet enters said by-pass pipe via said by-pass hole in the first place before getting in said air exhausting pipe, and then are led by said by-pass pipe to drop into said dust collecting tank through another dust dropping hole on the lower end of said by-pass pipe, this increases the recovery effect of said dust with smaller weight by said air whirling action.

4. A dust recovery device as in claim 3, wherein, a water bathing device is provided at the tailing end of said air exhausting pipe, said water bathing device has a water bathing tank as a main member thereof with water at a level; said water bathing tank has at one side thereof a water feed-in control set, and has therein a receiving chamber to be extended therein an air discharging end of said air exhausting pipe which is provided on said air discharging end with an air concentration lid, a water level hole is provided on said air concentration lid; said water bathing tank has near the bottom thereof a water outlet and a water drain pipe, said water outlet is provided thereon with a switch for controlling volume of water flow; said water outlet and said water drain pipe of said water bathing tank are located beneath said air concentration lid, the height of said water outlet is about a standard water level of said water bathing tank, while the height of said water drain pipe is close to the top inner surface of said air concentration lid; said water feed-in control set includes a water inlet pipe and a water level control room, wherein, said water inlet pipe is connected to the lower portion of said water bathing tank through an electromagnetic valve and a ball valve to control volumes of water feeding and discharging and to maintain said standard water level in said water bathing tank; said water inlet pipe is connected with said water level control room which has therein a ball float and communicates on the bottom thereof with the bottom of said water bathing tank through a communicating pipe.

5. A dust recovery device as in claim 4, wherein, said water bathing tank can be provided at the upper portion thereof with a water stop member to prevented water in said water bathing tank from spattering outwardly by blowing of airflow.

6. A dust recovery device as in claim 1, wherein, said tailing end of said air exhausting pipe of said centrifuge cylinder is connected further with a second centrifuge cylinder, said air discharging end of said air exhausting pipe is directly connected to an air vortex generator provided in said second centrifuge cylinder, in order that said air flow further generates an air whirling action in said second centrifuge cylinder to evolve the dust remaining in said second airflow.

7. A dust recovery device as in claim 6, wherein, said second centrifuge cylinder is provided on the upper wall thereof with a by-pass hole connected to a by-pass pipe, a slag discharging gate is directly provided on the lower end of said second centrifuge cylinder for clearing of the dust dropping in said second centrifuge cylinder.
